(19) United States
(12) Patent Application Publication
(10) Pub. No.: US 2016/0073341 A1
(43) Pub. Date: Mar. 10, 2016

(54) METHOD AND APPARATUS FOR OPTIMIZING POWER CONSUMPTION EFFICIENCY OF USER EQUIPMENT

(71) Applicant: ALCATEL LUCENT, Paris (FR)

(72) Inventors: Hua Chao, Shanghai (CN); He Wang, Shanghai (CN)

(73) Assignee: Alcatel Lucent, Boulogne Billancourt (FR)

(21) Appl. No.: 14/782,675

(22) PCT Filed: Mar. 24, 2014
(86) PCT No.: PCT/IB2014/000799

§ 371 Date: Oct. 6, 2015

(30) Foreign Application Priority Data
Apr. 6, 2013 (CN) 201310117017.0

(51) Int. Cl. H04W 52/02; H04W 76/04; H04W 4/00

(52) U.S. Cl. CPC H04W 52/0212; H04W 4/005; H04W 76/046; H04W 88/02

(57) ABSTRACT

An objective of the present invention is to provide a method and apparatus for optimizing power consumption efficiency of user equipment. Specifically, the user equipment sends power saving related information corresponding to the user equipment to a corresponding network device; the network device determines to activate or deactivate the active timer of the user equipment in a NAS idle state; when it is determined to activate the active timer, the network determines an activation value in setting information of the active timer based on the power saving related information or ancillary reference information of the active timer; the network device sends the setting information of the active timer to the user equipment. In this way, the network may perform power saving setting processing according to the actual application need of the user equipment, which not only further optimizes the power consumption efficiency of the user equipment but also enhances the management efficiency for user equipment power saving control.

### FIELD OF THE INVENTION

The present invention relates to the field of wireless communications, and more specifically, to a technique of optimizing power consumption efficiency of user equipment.

### BACKGROUND OF THE INVENTION

Recently, the task force SA2 of the international standardization group 3GPP approved a new work item (WI) named “Machine-type and Other Mobile Data Applications Communications Enhancement” for the REL 12 Machine Type Communication (MTC). This WI consists of four parts. In the present invention, only one part is concerned, i.e., UE Power Consumption Optimizations (UEPCOP).

During the discussions for UEPCOP, a new ECM (EPS Connection Management) model at the NAS (Non-Access Stratum) is defined in the 3GPP protocol TR 23. 887. In this new model, a new ECM hibernation state is defined, as shown in FIG. 1. The basic idea is to limit the reachable time length when the user equipment (hereinafter, “user equipment” and “UE” will be used alternately). In section 7.1.3.3 of the protocol, the UE uses an active timer to control the reachable time length of a paging message. The timer is initiated each time when the UE enters into an idle state. When the UE migrates to the hibernation state, the UE would not be paged. For those downlink MTC applications that may delay the sending time, e.g., software update, configuration information update, etc., such mechanism would have no problem. However, for those applications that need to trigger the uplink report in real-time, e.g., video monitoring, loss of a paging message, etc., it is unacceptable. Therefore, not all user equipments are suitable for adopting such a method of optimizing terminal power consumption. The network needs an essential flow and mechanism to select suitable user equipments and allow them to enter into the hibernation state. Besides, when user equipment's power saving need changes, the network has to perform a corresponding processing.

### SUMMARY OF THE INVENTION

An objective of the present invention is to provide a method and apparatus for optimizing power consumption efficiency of user equipment.

According to one aspect of the present invention, there is provided a method of optimizing power consumption efficiency of user equipment, wherein the method comprises the following steps:

a. sending, by the user equipment, power saving-related information corresponding to the user equipment, to a corresponding network device;

b. determining, by the network device, activation or deactivation of an active timer corresponding to the user equipment in a NAS idle state;

c. when it is determined to activate the active timer, determining, by the network device, an activation value in setting information of the active timer based on the power saving related information or ancillary reference information of the active timer;

d. sending, by the network device, setting the information of the active timer, to the user equipment.

According to another aspect of the present invention, there is further provided user equipment for optimizing power consumption efficiency of user equipment, wherein the apparatus comprises:

a first sending module configured to send power saving-related information corresponding to the user equipment, to a corresponding network device;

a first receiving module configured to receive setting information of an active timer sent from the network device and corresponding to the power saving related information.

According to a further aspect of the present invention, there is further provided a network device for optimizing power consumption efficiency of user equipment, wherein the network device comprises:

a second receiving module configured to receive power saving related information sent from the user equipment and corresponding to the user equipment;

a first determining module configured to determine activation or deactivation of an active timer corresponding to the user equipment in a NAS idle state;

a second determining module configured to determine, when it is determined to activate the active timer, an activation value in setting information of the active timer based on the power saving related information or ancillary reference information of the active timer;

a second sending module configured to send the setting information of the active timer, to the user equipment.

According to a still further aspect of the present invention, there is further provided a communication system for optimizing power consumption efficiency of user equipment, wherein the communication system comprises at least one user equipment as aforementioned and a network device as aforementioned.

Compared with the prior art, the present invention provides power saving related information to the network device through the user equipment; the network device determines the setting information of an active timer corresponding to the user equipment in the NAS idle state such that the network device may perform power saving setting processing according to the actual application need of the user equipment. In this way, it not only further screens suitable user equipments that require power saving control, but also improves the response promptness of the network device to the power saving demand of the user equipment, thereby enhancing the management efficiency for user equipment power saving control. Moreover, the network device may also determine the activation value in the setting information of the active timer based on the recommended value about the active timer as provided by the user equipment and/or the ancillary reference information of the active timer, so as to obtain a better active timer for the user equipment, which further optimizes the user equipment power consumption efficiency. Additionally, the user equipment further introduces the RRC-layer residing hibernation state, such that the RRC-layer signaling in the user equipment can simultaneously perform state switch with respect to the non-access stratum of the user equipment, which not only enhances the state switch efficiency, but also optimizes the user equipment power consumption efficiency.

### BRIEF DESCRIPTION OF THE ACCOMPANYING DRAWINGS

Through reading the detailed depiction of the non-limiting embodiments with reference to the accompanying drawings, other features, objectives and advantages of the present invention will become more apparent:

FIG. 1 shows a diagram of an ECM state model as a NAS example in user equipment;

FIG. 2 shows a flow chart of a method for optimizing power consumption efficiency of user equipment according to one aspect of the present invention;

FIG. 3 shows a diagram of an ECM state model as an NAS example, a paging period, and a periodical update timer;

FIG. 4 shows a state migration diagram of user equipment in a RRC idle state;

FIG. 5 shows a diagram of an apparatus for optimizing power consumption efficiency of user equipment according to another aspect of the present invention.

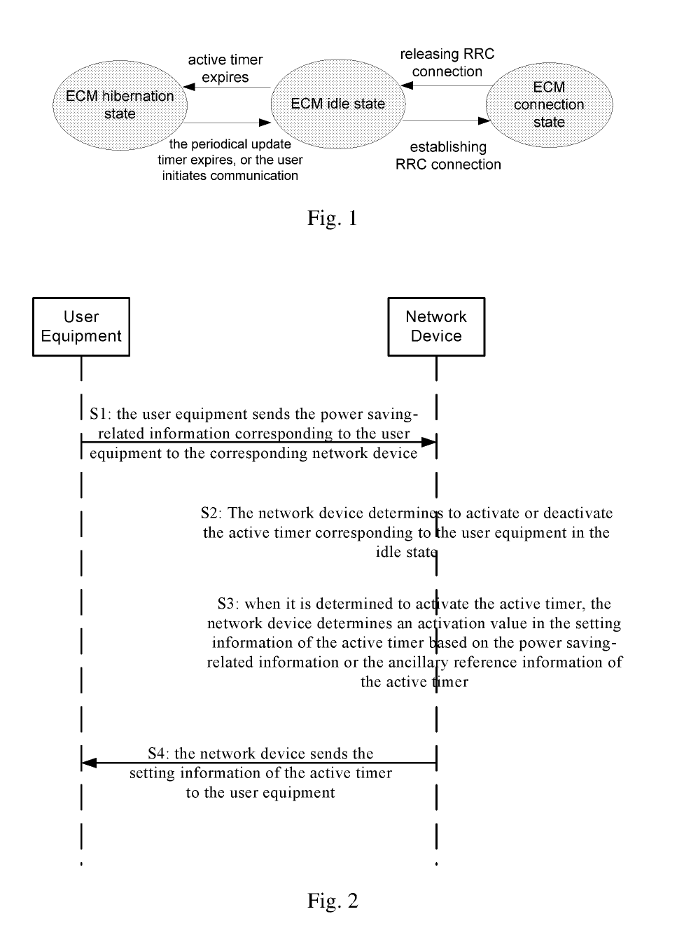

Same or similar reference numerals in the drawings represent same or similar components.

### DETAILED DESCRIPTION OF THE PREFERRED EMBODIMENTS

Hereinafter, the description will be described in further detail with reference to the accompanying drawings.

The inventors believe that the prior art has many unreasonable issues. For example, it should be a UE's active, rather than passive, behavior to enter into a power saving state, because the UE itself knows its participating application and corresponding need of power saving. If the UE does not want the network to suspend a paging process, it should not respond only after the network has assigned an active timer. Instead, the UE may select a value of the active timer on its own and informs the network before the network assigns the active timer. The UE can select the value of the timer rather than whether to finally adopt the value of the timer assigned by the network.

On that basis, FIG. 2 shows a flowchart of a method for optimizing power consumption efficiency of user equipment, wherein at step S1, the user equipment sends power saving related information corresponding to the user equipment to a corresponding network device; at step S2, the network determine determines activation or deactivation of an active timer corresponding to the user equipment in a NAS idle state; at step S3, when it is determined to activate the active timer, the network device determines an activation value in setting information of the active timer based on the power saving related information or ancillary reference information of the active timer; at step S4, the network device sends the setting information of the active timer to the user equipment.

Here, the NAS idle state includes, but not limited to, a PMM (Packet Mobility Management) idle state or an ECM idle state in the EPS Connection Management model. For the sake of brevity, the embodiments will be illustrated with ECM idle state as an example hereinafter, where “NAS idle state” and “ECM idle state,” or “NAS hibernation state,” and “ECM hibernation state” will be used without discrimination. Those skilled in the may determine directly and undoubtedly determine the embodiments corresponding to the PMM idle state according to the embodiments of the present application.

Specifically, at step S1, the user equipment sends power saving related information corresponding to the user equipment (e.g., power saving indication information and normal work indication information of the user equipment, recommended activation value of the active timer of the user equipment, or any combination of the above) to a corresponding network device (e.g., Mobility Management Entity MME) via its corresponding eNB base station. Here, the network device includes, but not limited to, MME, SGSN (HPRS service supporting node), etc. For the sake of brevity, the embodiments are only illustrated with MME as an example hereinafter, where “network device” and “MME” will be used without discrimination. Those skilled in the art may determine directly and undoubtedly determine the embodiments corresponding to SGSN and other network devices according to the embodiments of the present application.

For example, when the network device is an MME, the power saving indication information and/or normal work indication information belong to the power saving preferential information of the UE. For example, at step S1, the user equipment sends the power saving related information corresponding to the user equipment to a corresponding eNB base station or other access device using a corresponding RRC signaling, for example, including the power saving related information into the user ancillary information of the RRC to the corresponding eNB base station; the access device uses an interfacing signaling corresponding to the network device to send the power saving related information to the corresponding network device, e.g., the eNB base station sends the power saving related information to the corresponding MME using the corresponding S1 interface signaling (e.g., UE context release request). Next, in step S4, the network device uses the interface signaling corresponding to the access device to send the setting information of the active timer to the access device, e.g., the MME uses the corresponding S1 interface signaling (e.g., UE context release command) to send the setting information of the active timer to the eNB base station; the access device such as the eNB base station uses a corresponding RRC signaling (e.g., RRC connection release command) to send the setting information of the active timer to the user equipment.

For another example, when the network device is MME, if the power saving related information includes a recommended activation value about the active timer of the user equipment, at step S1, the user equipment sends the power saving related information corresponding to the user equipment using an attachment and/or periodical update process to the corresponding MME; next, at step S4, the MME sends the setting information of the active timer with the attachment and/or periodical update process to the user equipment. Here, the UE indicates its power saving preferential information to the network by adopting the existing attachment and/or periodical update process including the location update, route area update, and/or tracking area update process. For example, carrying the UE's power saving preferential information in the attachment and/or periodical update request message; after the network receives the information, sending the assigned active timer to the UE in the attachment and/or periodical update reception message. Those skilled in the art would appreciate that the UE can change its power saving preference without waiting for its entry into the RRC connection state, which also reduces the overheads of information transmission and saves power consumption. Here, those skilled in the art should understand that when the network device is SGSN, the corresponding access device should be RNC (Radio Network Controller).

Those skilled in the art should understand that the above power saving related information and its transmission manner are only examples, and other existing or future possibly evolving power saving related information or its transmission manner, if applicable to the present invention, should also be included within the protection scope of the present invention and should be incorporated here by reference.

In step S2, the network device determines an operation on the corresponding active timer when the user equipment is in the NAS idle state to activate the active timer or deactivate the active timer. For example, the network device infers based on the power saving indication information provided by the user equipment that the user equipment intends to save power consumption and therefore determines to activate the active timer corresponding to the ECM idle state of the user equipment in the EPS connection management model. For another example, the network device infers based on the normal work indication information provided by the user equipment that the user equipment intends to work normally rather than save power consumption, and thus determines to deactivate the active timer corresponding to the ECM idle state of the user equipment in the EPS connection management model. For another example, the network device may also infer based on the work condition of the user equipment as detected thereby (e.g., the user equipment is now in a normal work state) that the user equipment intends to work normally rather than save power, and thus determines to deactivate the active timer corresponding to the ECM idle state of the user equipment in the EPS connection management model.

Preferably, in step S2, based on the predetermined activation rule, the network device determines to activate or deactivate the active timer corresponding to the user equipment in the NAS idle state based on a predetermined activation rule, wherein the predetermined activation rule includes at least one of the following items:
when the power saving related information includes power saving indication information of the user equipment, the network device determines to activate the active timer;
when the power saving related information includes normal work indication information of the user equipment, the network device determines to deactivate the active timer;
when the network device detects that the user equipment is in a normal work state, the network device determines to deactivate the active timer.

Those skilled in the art should understand that the above activation rule is only an example, and other existing or future possibly evolving activation rule, if applicable to the present invention, should also be included within the protection scope of the present invention and should be incorporated here by reference.

In step S3, when it is determined to activate the active timer, the network device determines an activation value in setting information of the active timer (e.g., taking the determined activation value as the setting information of the active timer or a part thereof) based on the power saving related information (e.g., recommended activation value of the user equipment about the active timer), or ancillary reference information of the active timer (e.g., the value of the active timer customized by the UE as stored in the home subscriber server (HSS)). For example, the network device directly regards the recommended activation value in the power saving related information as the activation value in the setting information of the corresponding active timer. For another example, the network device regards a smaller value among the recommended activation value in the power saving related information, the value of the active timer customized by the UE and the like as the activation value in the setting information of the active timer. Here, the activation value may be a non-zero value to correspond to the timing length of the active timer; correspondingly, the deactivation value may be a zero value or other predetermined identifier so as to be available for the user equipment to determine that its corresponding active timer is deactivated.

Preferably, in step S3, when it is determined to activate the active timer, the network device determines the activation value in the setting information of the active timer based on the power saving related information in conjunction with the ancillary reference information of the active timer, wherein the power saving related information includes a recommended activation value about the active timer of the user equipment; wherein the ancillary reference information includes at least one of the following items:
customized information about the active timer of the user equipment;
machine-type communication application information corresponding to the user equipment;
local configuration information of the network where the user equipment is located.

For example, the network device determines the activate value of the setting information corresponding to the active timer based on the recommended activation value in the power saving related information in conjunction with the ancillary reference information, e.g., the machine-type communication application information corresponding to the user equipment, such as a monthly remote meter reading application.

Here, the timing length of the active timer should be long enough to support the UE to perform the following work: 1) performing necessary measurement and reselection of potential cell, wireless access technology and/or network; 2) performing a periodical update process; 3) monitoring the paging channel and collecting paging messages where necessary.

Those skilled in the art should understand that the above ancillary reference information is only exemplary, and other existing or future possibly evolving ancillary reference information, if applicable to the present invention, should also be included within the protection scope of the present invention and should be incorporated here by reference.

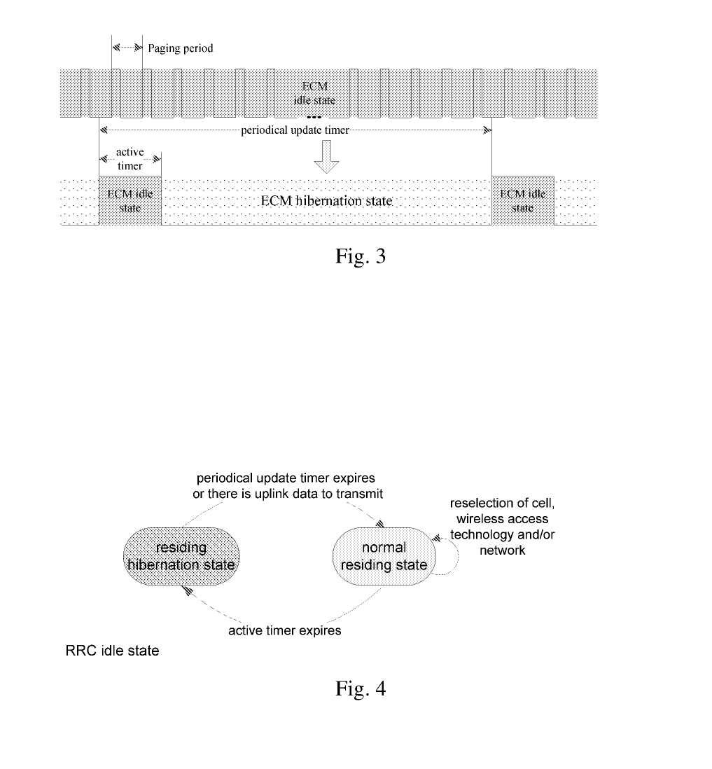

In step S4, the network device sends the setting information of the active timer to the user equipment for example in a manner corresponding to step S1. Those skilled in the art may determine the implementation manner of S4 based on the embodiment corresponding S1, which is therefore not detailed here, but incorporated here by reference. The periodical update timer is used by the network for checking whether the UE is reachable, which is known information to those skilled in the art. Since the periodical update timer is not changed in the prior art, particularly it is not affected after introducing new ECM hibernate mode, as shown in FIG. 3, the role played by the new ECM model is extending the UE paging period to equal to the length of the periodical update timer. It is seen that the value of the active has no direct relationship with the value of the periodical update timer, although the value of the active timer must be less than the value of the periodical update timer. The time length of the active timer is just the time length in which the UE can receive the paging message. It should be noted that, the UE needs to migrate from the idle state to the connection state during performing the periodical update process. For the sake of simplicity, the connection state is not shown in FIG. 3.

According to another aspect of the present invention, because the ECM model in the prior art belongs to a Non-Access Stratum (NAS) concept, the active timer is assigned to the UE by the network. A corresponding hibernate mode should also be introduced in the RRC state machine at the access stratum AS, such that the NAS and the AS can cooperate to work well. However, at present, a RRC state corresponding to the ECM hibernation state is not available yet.

In a preferred embodiment (see FIG. 2), the method further comprises a step S5 (not shown), wherein if the setting information of the active timer includes an activation value, when the user equipment enters into the NAS idle state, the active timer is initiated; when the active timer expires, the user equipment migrates from the NAS idle state to the corresponding NAS hibernation state.

Preferably, the step S3 further comprises when it is determined to deactivate the active timer, determining, by the network device, a deactivation value in the setting information of the active timer; in step S5, when the setting information of the active timer includes the deactivation value, the user equipment is forbidden to enter into the NAS hibernation state.

Preferably, the step S5 further comprises: if the setting information of the active timer includes the activation value, when the user equipment enters into the NAS idle state, the user equipment enters in the normal residing state in the RRC idle state; when the active timer expires, the user equipment migrates from the normal residing state to the residing hibernation state in the RRC idle state; wherein the residing hibernation state includes at least one of the following features:
forbidding the user equipment to perform measurement and reselection of a cell, wireless access technology, and network;
forbidding the user equipment to perform a mobility related process;
forbidding the user equipment to perform system information block monitoring;
forbidding the user equipment to perform paging monitoring.

Here, the state migration diagram in the RRC idle state of the user equipment is shown in FIG. 4. When in the normal residing state, the UE may process the following tasks:

1) selecting and monitoring a paging channel during a period of time defined by the active timer; when the timer expires, the UE enters into the residing hibernation state to save power;

2) each time when the UE returns to the residing idle state from the residing hibernation state, the UE may reads the system information block and performs necessary measurement required by the cell reselection evaluation process;

performing the cell reselection process to select the best cell; next, migrating to the connection mode to be available for the update data transmission or periodical update process (including location update, routing area update, and tracking area update process).

More preferably, the method further comprises step S6 (not shown) after the step S5: when the periodical update timer expires or there is an uplink transmission need, the user equipment migrates from the NAS hibernation state to the NAS idle state and migrates from the residing hibernation state to the normal residing state. Then, the method may further include a step S7 (not shown) after the step S6: the user equipment performs a measurement corresponding to the periodical update timer or the uplink transmission need, and a cell, wireless access technology and/or network reselection process, and performs the corresponding periodical update process or uplink data sending process.

The classification of the MTC communication needs is defined in protocol 22.368. The present invention focuses on a low-mobility MTC device. The low-mobility MTC device refers to a MTC device that cannot move, or moves little, or only moves within a certain area, for example, an automatic vending machine, an intelligent measurement, and a city automated device. These devices are particularly suitable for the RRC hibernation state of the present invention.

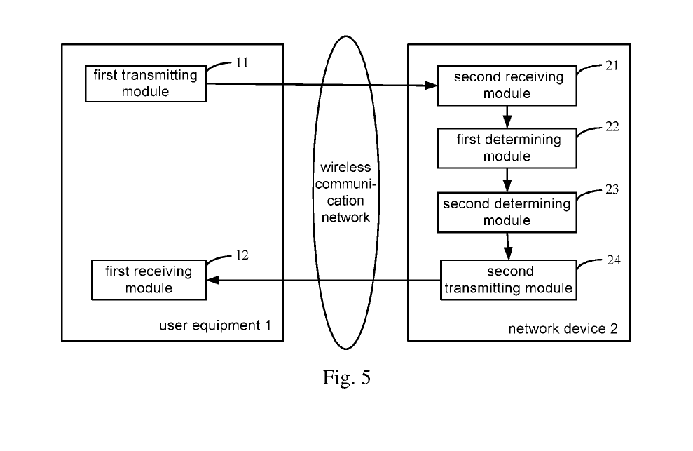

FIG. 5 shows a diagram of an apparatus for optimizing power consumption efficiency of user equipment according to one aspect of the present invention, wherein the user equipment 1 comprises a first sending module 11 and a first receiving module 12, a network device 2 comprises a second receiving module 21, a first determining module 22, a second determining module 23, and a second sending module 24.

The first sending module 11 of the user equipment sends power saving related information corresponding to the user equipment to the corresponding network device; correspondingly, the second receiving module 21 of the network device 2 receives the power saving related information sent by the user equipment and corresponding to the user equipment; the first determining module 21 determines to activate or deactivate an active timer corresponding to the user equipment in a NAS idle state; when it is determined to activate the active timer, the second determining module 23 determines an activation value in setting information of the active timer based on the power saving related information or the ancillary reference information of the active timer; the second sending module 24 sends the setting information of the active timer to the user equipment; correspondingly, the first receiving module 21 of the user equipment 1 receives setting information of the active timer sent by the network device and corresponding to the power saving related information.

Specifically, the first sending module 11 sends power saving related information (e.g., power saving indication information and normal work indication information of the user equipment, recommended activation value of the active timer of the user equipment, or any combination of the above) to a corresponding network device (e.g., Mobility Management Entity MME) via its corresponding access device such as an eNB base station. Here, the power saving indication information and/or normal work indication information belongs to the power saving preferential information of the UE. For example, the first sending module 11 sends the power saving related information corresponding to the user equipment to the corresponding eNB base station via a corresponding RRC signaling, e.g., including the power saving related information in the RRC user ancillary information to send to the corresponding eNB; the eNB base station uses the corresponding S1 interface signaling (e.g., UE context release request) to send the power saving related information to the corresponding network device; correspondingly, the second receiving module 21 receives power saving related information sent from the eNB base station and corresponding to the user equipment. Next, the second sending module 24 uses a corresponding S1 interface signaling (e.g., UE context release command) to send the setting information of the active timer to the eNB base station; the eNB base station uses a corresponding RRC signaling (e.g., RRC connection release command) to send the setting information of the active timer to the user equipment; correspondingly, the first receiving module 12 receives the setting information of the active timer sent by the eNB base station and corresponding to the power saving related information.

For another example, when the power saving related information includes a recommended activation value of the user equipment about the active timer, the first sending module 11 sends the power saving related information corresponding to the user equipment to the corresponding network device with an attachment and/or periodical update process; correspondingly, the second receiving module 21 of the network device 2 receives the power saving related information sent by the user equipment and corresponding to the user equipment; next, the second sending module 24 sends the setting information of the active timer to the user equipment with the attachment and/or periodical update process; correspondingly, the first receiving module 12 of the user equipment 1 receives the setting information of the active timer sent by the network device and corresponding to the power related information. Here, the UE indicates the network its power saving preferential information adopting the existing attachment and/or periodical update process (including location update, routing area update and/or tracking area update process). For example, in the attachment and/or periodical update request message, carrying the UE's power saving preferential information; after the network receives it, sending the assigned active timer to the UE in an attachment and/or periodical update reception message. Those skilled in the art would appreciate that the UE needs not to wait for its entry into the RRC connection state before changing its power saving preference, which also reduces the overheads of information transmission and saves power consumption.

Those skilled in the art should understand that the above power saving related information and its transmission manner are only exemplary, and other existing or future possibly evolving power saving related information or its transmission manner, if applicable to the present invention, should also be included within the protection scope of the present invention and is incorporated here by reference.

The first determining module 22 determines an operation on the active timer corresponding to the user equipment in the NAS idle state to activate the active timer or deactivate the active timer. For example, the network device infers based on the power saving indication information provided by the user equipment that the user equipment intends to save power consumption and thus determines to activate the active timer corresponding to the user equipment in the NAS idle state. For another example, the network device infers based on the normal work indication information provided by the user equipment that the user equipment intends to work normally rather than save power consumption, and thus determines to deactivate the active timer corresponding to the ECM idle state of the user equipment in the EPS connection management model. For another example, the network device may also infer based on the work condition of the user equipment as detected thereby (e.g., the user equipment is now in a normal work state) that the user equipment intends to work normally rather than save power, and thus determines to deactivate the active timer corresponding to the ECM idle state of the user equipment in the EPS connection management model.

Preferably, the first determining module 22 determines to activate or deactivate the active timer corresponding to the user equipment in the NAS idle state based on a predetermined activation rule, wherein the predetermined activation rule includes at least one of the following items:
when the power saving related information includes power saving indication information of the user equipment, the network device determines to activate the active timer;
when the power saving related information includes normal work indication information of the user equipment, the network device determines to deactivate the active timer;
when the network device detects that the user equipment is in a normal work state, the network device determines to deactivate the active timer.

Those skilled in the art should understand that the above activation rule is only an example, and other existing or future possibly evolving activation rule, if applicable to the present invention, should also be included within the protection scope of the present invention and should be incorporated here by reference.

When it is determined to deactivate the active timer, the second determining module 23 determines an activation value in setting information of the active timer (e.g., taking the determined activation value as the setting information of the active timer or a part thereof) based on the power saving related information (e.g., recommended activation value of the user equipment about the active timer), or ancillary reference information of the active timer (e.g., the value of the active timer customized by the UE as stored in the home subscriber server (HSS)). For example, the network device directly regards the recommended activation value in the power saving related information as the activation value in the setting information of the corresponding active timer. For another example, the network device regards a smaller value among the recommended activation value in the power saving related information, the value of the active timer customized by the UE and the like as the activation value in the setting information of the active timer. Here, the activation value may be a non-zero value to correspond to the timing length of the active timer; correspondingly, the deactivation value may be a zero value or other predetermined identifier so as to be available for the user equipment to determine that its corresponding active timer is deactivated.

Preferably, when it is determined to activate the active timer, the second determining module 23 determines the activation value in the setting information of the active timer based on the power saving related information in conjunction with the ancillary reference information of the active timer, wherein the power saving related information includes a recommended activation value about the active timer of the user equipment; wherein the ancillary reference information includes at least one of the following items:
customized information about the active timer of the user equipment;
machine-type communication application information corresponding to the user equipment;
local configuration information of the network where the user equipment is located.

For example, the network device determines the activate value of the setting information corresponding to the active timer based on the recommended activation value in the power saving related information in conjunction with the ancillary reference information, e.g., the machine-type communication application information corresponding to the user equipment, such as a monthly remote meter reading application.

Here, the timing length of the active timer should be long enough to support the UE to perform the following work: 1) performing necessary measurement and reselection of potential cell, wireless access technology and/or network; 2) performing a periodical update process; 3) monitoring the paging channel and collecting paging messages where necessary.

Those skilled in the art should understand that the above ancillary reference information is only exemplary, and other existing or future possibly evolving ancillary reference information, if applicable to the present invention, should also be included within the protection scope of the present invention and should be incorporated here by reference.

The second sending module 24 sends the setting information of the active timer to the user equipment for example in a manner corresponding to the first sending module 11. Those skilled in the art may determine the implementation manner of the second sending module 24 based on the embodiment corresponding to the first sending module 11, which is therefore not detailed here, but incorporated here by reference. The periodical update timer is used by the network for checking whether the UE is reachable, which is known information to those skilled in the art. Since the periodical update timer is not changed in the prior art, particularly it is not affected after introducing new ECM hibernate mode, as shown in FIG. 3, the role played by the new ECM model is extending the UE paging period to equal to the length of the periodical update timer. It is seen that the value of the active has no direct relationship with the value of the periodical update timer, although the value of the active timer must be less than the value of the periodical update timer. The time length of the active timer is just the time length in which the UE can receive the paging message. It should be noted that, the UE needs to migrate from the idle state to the connection state during performing the periodical update process. For the sake of simplicity, the connection state is not shown in FIG. 3.

According to another aspect of the present invention, because the ECM model in the prior art belongs to a Non-Access Stratum (NAS) concept, the active timer is assigned to the UE by the network. A corresponding hibernate mode should also be introduced in the RRC state machine at the access stratum AS, such that the NAS and the AS can cooperate to work well. However, at present, a RRC state corresponding to the ECM hibernation state is not available yet.

In a preferred embodiment (see FIG. 2), the apparatus further comprises a migrating module (not shown), wherein if the setting information of the active timer includes an activation value, when the user equipment enters into the NAS idle state, the active timer is initiated; when the active timer expires, the user equipment migrates from the NAS idle state to the corresponding NAS hibernation state.

Preferably, when it is determined to deactivate the active timer, the second determining module 23 determines a deactivation value in the setting information of the active timer; when the setting information of the active timer includes the deactivation value, the migrating module forbids the user equipment to enter into the NAS hibernation state.

Preferably, the migrating module is further configured to: if the setting information of the active timer includes the activation value, when the user equipment enters into the NAS idle state, the user equipment enters in the normal residing state in the RRC idle state; when the active timer expires, the user equipment migrates from the normal residing state to the residing hibernation state in the RRC idle state; wherein the residing hibernation state includes at least one of the following features:
forbidding the user equipment to perform measurement and reselection of a cell, wireless access technology, and network;
forbidding the user equipment to perform a mobility related process;
forbidding the user equipment to perform system information block monitoring;
forbidding the user equipment to perform paging monitoring.

Here, the state migration diagram in the RRC idle state of the user equipment is shown in FIG. 4. When in the normal residing state, the UE may process the following tasks:

1) selecting and monitoring a paging channel during a period of time defined by the active timer; when the timer expires, the UE enters into the residing hibernation state to save power;

2) each time when the UE returns to the residing idle state from the residing hibernation state, the UE may reads the system information block and performs necessary measurement required by the cell reselection evaluation process; performing the cell reselection process to select the best cell; next, migrating to the connection mode to be available for the update data transmission or periodical update process (including location update, routing area update, and tracking area update process).

To those skilled in the art, it is apparent that the present invention is not limited to the details of the above exemplary embodiments, and the present invention may be implemented with other embodiments without departing from the spirit or basic features of the present invention. Thus, in any way, the embodiments should be regarded as exemplary, not limitative; the scope of the present invention is limited by the appended claims, instead of the above depiction. Thus, all variations intended to fall into the meaning and scope of equivalent elements of the claims should be covered within the present invention. No reference signs in the claims should be regarded as limiting the involved claims. Besides, it is apparent that the term “comprise” does not exclude other units or steps, and singularity does not exclude plurality. A plurality of units or modules stated in a system claim may also be implemented by a single unit or module through software or hardware. Terms such as the first and the second are used to indicate names, but do not indicate any particular sequence.

1. A method for optimizing power consumption efficiency of a user equipment, wherein the method comprises the following:
sending, by the user equipment, power saving-related information corresponding to the user equipment, to a corresponding network device;
determining, by the network device, activation or deactivation of an active timer corresponding to the user equipment in a NAS idle state;
when it is determined to activate the active timer, determining, by the network device, an activation value in setting information of the active timer based on the power saving-related information or ancillary reference information of the active timer;
sending, by the network device, the setting information of the active timer, to the user equipment.

2. The method according to claim 1, wherein the method further comprises:
if the setting information of the active timer includes an activation value, when the user equipment enters into the NAS idle state, starting the active timer;
when the active timer expires, migrating, by the user equipment, from the NAS idle state to a corresponding NAS hibernation state.

3. The method according to claim 2, wherein the determining an activation value further comprises:
when it is determined to deactivate the active timer, the network device determines a deactivation value in the setting information of the active timer;
wherein the step x further comprises:
when the setting information of the active timer includes the deactivation value, the user equipment is forbidden to enter into the NAS hibernation state.

4. The method according to claim 2 further comprising:
if the setting information of the active timer includes an activation value, when the user equipment enters into the NAS idle state, the user equipment entering into a normal residing state in a RRC idle state;
when the active timer expires, the user equipment migrating from the normal residing state into a residing hibernation state in the RRC idle state;
wherein the residing hibernation state includes at least any one of the following features:
forbidding the user equipment to perform measurement and reselection of a cell, wireless access technology, and network;
forbidding the user equipment to perform a mobility related process;
forbidding the user equipment to perform system information block monitoring;
forbidding the user equipment to perform paging monitoring.

5. The method according to claim 4, further comprising:
when a periodical update timer expires or there is an uplink transmission need, the user equipment migrating from the NAS hibernation state into the NAS idle state, and migrating from the residing hibernation state into the normal residing state.

6. The method according to claim 5, further comprising:
the user equipment performing a measurement and a cell reselection process corresponding to the periodical update timer or the uplink transmission need, and performing a corresponding periodical update process or an uplink data transmission process.

7. The method according to claim 1, wherein the determining activation or deactivation comprises:
determining, by the network device, to activate or deactivate an active timer corresponding to the user equipment in a NAS idle state based on a predetermined activating rule;
wherein the predetermined activating rule comprises at least any one of the following items:
when the power saving-related information includes power saving indication information of the user equipment, the network device determines to activate the active timer;
when the power saving-related information includes normal working indication information of the user equipment, the network device determines to deactivate the active timer;
when the network device detects that the user equipment is in a normal working state, the network device determines to deactivate the active timer.

8. The method according to claim 1, wherein the determining an activation value comprises:
when it is determined to activate the active timer, the network device determines the activation value in the setting information of the active timer based on the power saving-related information in conjunction with the ancillary reference information of the active timer, wherein the power saving-related information includes a recommended activation value about the active timer of the user equipment;
wherein the ancillary reference information includes at least one of the following items:
customized information about the active timer of the user equipment;
machine-type communication application information corresponding to the user equipment;
local configuration information of the network where the user equipment is located.

9. The method according to claim 8, wherein the sending by the user equipment comprises:
sending, by the user equipment, power saving-related information corresponding to the user equipment to the corresponding network device with an attachment and/or periodical update process, wherein the power saving-related information includes a recommended activation value about the active timer of the user equipment;
wherein the step d comprises:
sending, by the network device, the setting information of the active timer to the user equipment with the attachment and/or periodical update process.

10. The method according to claim 1, wherein the sending by the user equipment comprises:
sending, by the user equipment, the power saving-related information corresponding to the user equipment to the corresponding access device using a corresponding RRC signaling;
sending, by the access device, the power saving-related information to the corresponding network device using an interface signaling corresponding to the network device;
wherein the sending by the network device comprises:
sending, by the network device, the setting information of the active timer to the access device using an interface signaling corresponding to the access device;
sending, by the access device, the setting information of the active timer to the user equipment using a corresponding RRC signaling.

11. User equipment for optimizing power consumption efficiency of the user equipment, wherein the user equipment comprises:
a first sending module configured to send power saving-related information corresponding to the user equipment, to a corresponding network device;
a first receiving module configured to receive setting information of an active timer sent from the network device and corresponding to the power saving-related information.

12. The user equipment according to claim 11, wherein the user equipment further comprises a state migrating module configured to:
if the setting information of the active timer includes an activation value, when the user equipment enters into the NAS idle state, start the active timer;
when the active timer expires, migrate from the NAS idle state to a corresponding NAS hibernation state.

13. A network device for optimizing power consumption efficiency of user equipment, wherein the network device comprises:
a second receiving module configured to receive power saving-related information sent from the user equipment and corresponding to the user equipment;
a first determining module configured to determine activation or deactivation of an active timer corresponding to the user equipment in a NAS idle state;
a second determining module configured to determine, when it is determined to activate the active timer, an activation value in setting information of the active timer based on the power saving-related information or ancillary reference information of the active timer;
a second sending module configured to send the setting information of the active timer, to the user equipment.

14. The network device according to claim 13, wherein the second determining module is configured to:
when it is determined to activate the active timer, determine the activation value in the setting information of the active timer based on the power saving-related information in conjunction with the ancillary reference information of the active timer, wherein the power saving-related information includes a recommended activation value about the active timer of the user equipment;
wherein the ancillary reference information includes at least one of the following items:
customized information about the active timer of the user equipment;
machine-type communication application information corresponding to the user equipment;
local configuration information of the network where the user equipment is located.

15. A communication system for optimizing power consumption efficiency of user equipment, wherein the communication system comprises at least one user equipment comprising a first sending module configured to send power saving-related information corresponding to the user equipment, to a corresponding network device and a first receiving module configured to receive setting information of an active timer sent from the network device and corresponding to the power saving-related information, and a network device according to claim 13.
